(19) United States
(12) Patent Application Publication
(10) Pub. No.: US 2009/0283592 A1
(43) Pub. Date: Nov. 19, 2009

(54) COMMODITY SALES DATA PROCESSING APPARATUS

(75) Inventor: Yoichi Yamane, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/435,656

(22) Filed: May 5, 2009

(30) Foreign Application Priority Data
May 19, 2008 (JP) 2008-131230

(51) Int. Cl. G06K 15/00

(52) U.S. Cl. 235/383

(57) ABSTRACT

A checkout counter is used for checkout transactions performed by a store clerk and a customer face to face. The checkout counter is set between a waiting position of the store clerk and a waiting position of the customer. A commodity-code input apparatus is arranged on a downstream side of a flow of commodities on which the store clerk takes a commodity planned to be purchased by the customer and moves the commodity. A commodity code input by the commodity-code input apparatus is used for settlement by a POS terminal. An information display is arranged further on an upstream side of the flow of commodities than the commodity-code input apparatus. Information for customers lining up to wait for their turns for checkout transactions is displayed on the information display.

### CROSS REFERENCE TO RELATED APPLICATION

The present application is based on and claims the benefit of priority of Japanese Patent Application No. 2008-131230 filed on May 19, 2008, the entire contents of which is incorporated herein by reference.

### TECHNICAL FIELD

The present invention relates to a checkout system installed in a register area of a store such as a supermarket.

### BACKGROUND

Conventionally, a checkout system (e.g., FIGS. 5 to 7 and FIG. 9 of JP-A-9-152917) is installed in a store such as a supermarket. The checkout system realizes efficiency of checkout transactions performed between store clerks and customers.

The customers line up to wait for their turns for checkout transactions with the store clerks. When waiting time is too long, the customers are likely to feel stress (dissatisfaction).

### SUMMARY

It is an object of the present invention to eliminate stress (dissatisfaction) of customers who are waiting for their turns for checkout transactions.

According to the present invention, a self checkout terminal is provided which includes: a checkout counter that is arranged between a store clerk side and a customer side and specifies a moving path of customers on the customer side; a commodity-code input unit that is arranged on a top surface of the checkout counter and used for inputting commodity code; a settling unit that is arranged further on a downstream side than the commodity-code input unit in a flow of commodities in checkout transactions performed by using the commodity-code input unit and performs settlement based on a commodity code input from the commodity-code input unit; a display unit that is arranged offset to the store clerk side with respect to the checkout counter and has a display screen for displaying information; and an information processing unit that executes processing for causing the display unit to display display information, wherein the display screen is directed further to an upstream side of the flow than the commodity-code input unit and further to the upstream side than a position of an upstream end of the checkout counter in the moving path.

### DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is an external perspective view of a checkout system;

FIG. 2 is a block diagram of an electric configuration of the checkout system;

FIG. 3 is a schematic diagram of an example of information displayed on an information display; and

FIG. 4 is a plan view of a state in which customers stand in a line to wait for their turns for checkout transactions.

### DETAILED DESCRIPTION

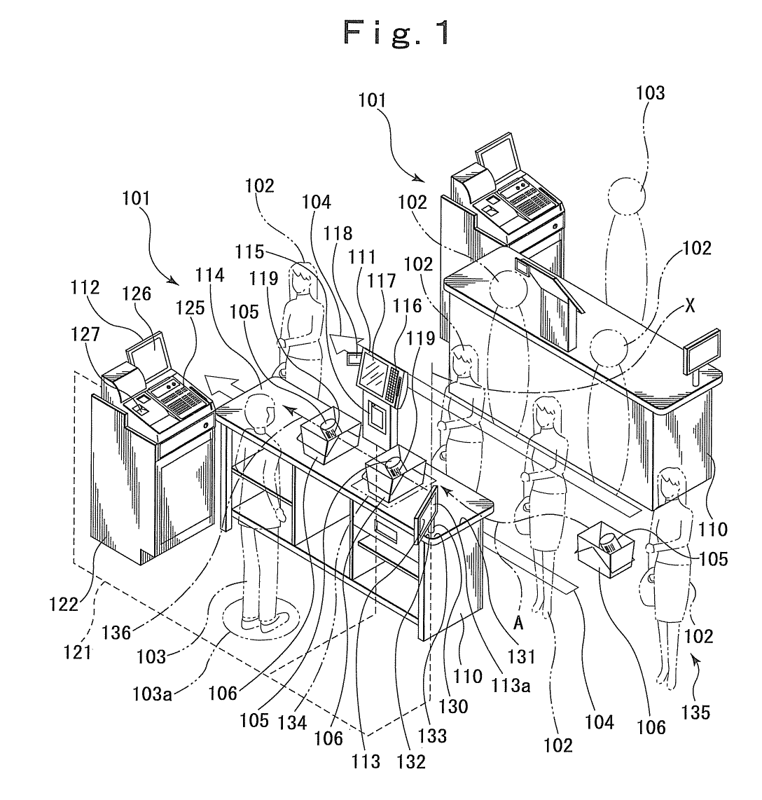

An embodiment of the present invention is explained with reference to FIGS. 1 to 4.

A checkout system 101 according to this embodiment causes customers and commodities carried by the customers to flow in one direction and realizes, in this flow in one direction, input of commodity codes by a commodity-code input unit and settlement by a settling unit. In the checkout system 101, a display unit is arranged further on an upstream side in the direction of the flow than the commodity-code input unit. Customers waiting for their turns are provided with information through display by the display unit.

FIG. 1 is an external perspective view of the checkout system 101. Two checkout counters 110 are set in a register area of a supermarket. These two checkout counters 110 are arranged to be spaced apart with long sides thereof opposed to each other. Two customer moving paths 104 on which a customer 102 moves are secured between the two checkout counters 110. The customer 102 moves forward along one of the customer moving paths 104 and faces the checkout counter 110 closer to the customer moving path 104. The customer 102 faces a store clerk 103 across the checkout counter 110 and performs checkout transactions with the store clerk 103 concerning a commodity 105 planned to be purchased. A checkout system 101 including the checkout counter 110 on a front side shown in FIG. 1 is explained below.

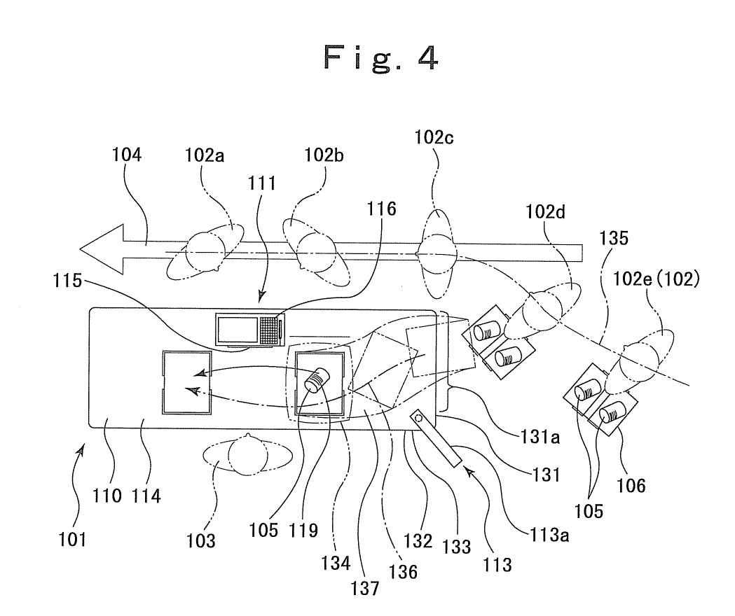

The checkout system 101 includes the checkout counter 110, a commodity-code input apparatus 111, a POS terminal 112, and an information display 113. The commodity-code input apparatus 111 and the information display 113 are connected to a POS terminal 112 by a connection cord 121 to be capable of freely performing data communication each other. The store clerk 103 stands in a waiting position 103a on the front side of FIG. 1 relative to the checkout counter 110. The store clerk 103 performs checkout transactions with the customer 102 (who moves from the right to the left in FIG. 1 on the customer moving path 104 and stands facing the store clerk 103). In the checkout transactions, the store clerk 103 positions a shopping basket 106 carried by the customer 102 in a basket placing area 134 (see FIG. 4 as well). Subsequently, the store clerk 103 inputs, using the commodity-code input apparatus 111, a commodity code 119 attached to the commodity 105 stored in the shopping basket 106 to the POS terminal 112. The store clerk 103 operates the POS terminal 112 and performs settlement based on the input commodity code 119. When the store clerk 103 performs settlement, the store clerk 103 carries the commodity 105 in one direction (a direction from the right to the left in FIG. 1) on a top surface of the checkout counter 110. In other words, a carrying path 136 along the flow of the commodity 105 is secured on the checkout counter 110.

The checkout counter 110 is a slim and long table parallel to the customer moving path 104. A long side of the checkout counter 110 is directed to a direction parallel to the customer moving path 104. The checkout counter 110 is set between the customer moving path 104 on the customer side and the waiting position 103a of the store clerk 103 on the store clerk side. A top plate 114 on which the shopping basket 106 is placed is attached to an upper part of the checkout counter 110. The checkout counter 110 specifies a direction in which a customer line 135 formed by customers 102 lining up to wait for their turns for checkout transactions extends.

The commodity-code input apparatus 111 is vertically provided in substantially the center of a width direction viewed from the store clerk side on a top surface of the top plate 114. In the commodity-code input apparatus 111, a code scanner 115, a keyboard 116, a scanning work display 117, a customer display 118 are integrated. The code scanner 115 scans, through a scanning window, a symbolized commodity code 119 attached to the commodity 105. The scanning work display 117 is attached to an upper part of the code scanner 115 with display screen thereof directed to the store clerk side. The customer display 118 is arranged to be directed to the customer side behind the scanning work display 117. The commodity-code input apparatus 111 is vertically provided in a portion closer to the customer side on the top surface of the top plate 114. Therefore, the store clerk 103 stands right opposed to the commodity-code input apparatus 111 and holds the commodity code 119 over the scanning window of the code scanner 115 to cause the code scanner 115 to scan the commodity code 119. A sufficient space area is secured above the top plate 114 between the commodity-code input apparatus 111 and the store clerk 103. The store clerk 103 can slide the shopping basket 106 from the right to the left.

A POS terminal setting table 122 is set on the left of the store clerk 103. The POS terminal 112 includes on a top surface thereof a keyboard 125, a settlement work display 126, and a receipt sheet discharge port 127.

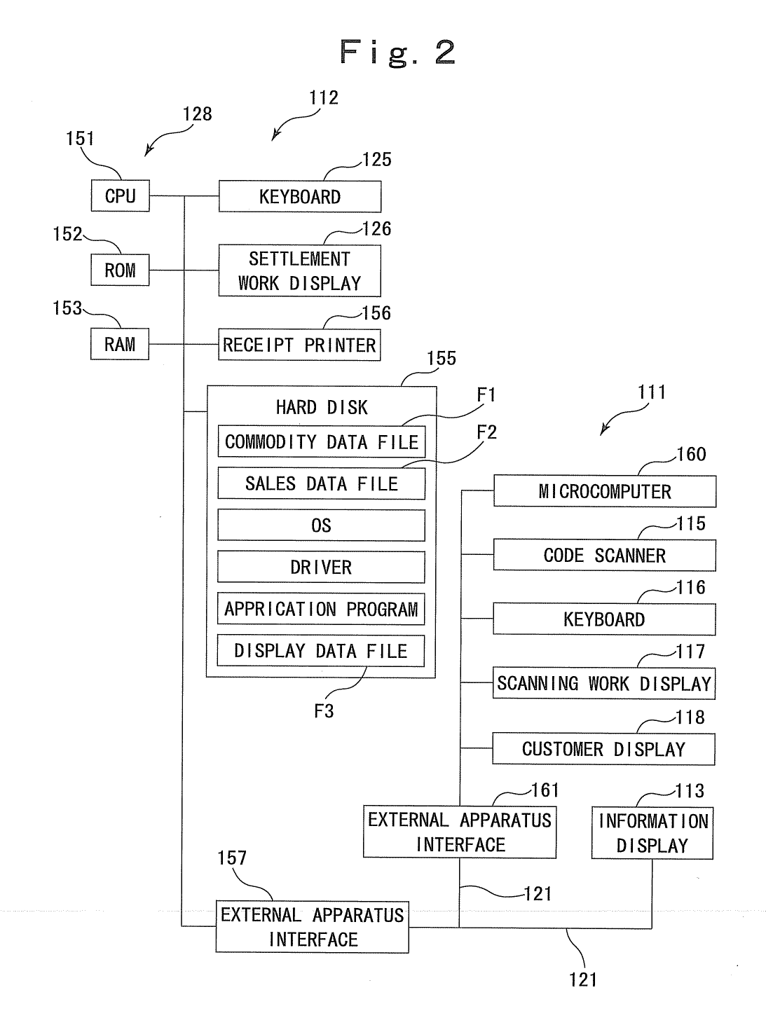

The information display 113 is arranged on the right side viewed from the store clerk 103 and above the top plate 114. A bottom surface of the information display 113 is supported by a pole 130. A connection cord 121 passes through the pole 130. The information display 113 is connected to the POS terminal 112 via the connection cord 121. The information display 113 is controlled by a microcomputer 128 (see FIG. 2) included in the POS terminal 112 to display various kinds of information. In other words, the information display 113 functions as a display unit that displays information. As an example of the information display 113, a liquid crystal display device can be adopted.

The pole 130 is provided near a corner 133 between an upstream end 131 of the top plate 114 on the right side viewed from the store clerk side and a store clerk side edge 132 of the top plate 114. The pole 130 vertically projects from the top plate 114. The information display 113 has a display screen 113a on which display is performed (see FIGS. 1 and 4). The display screen 113a is directed to the customer line 135 of the customers 102 lining up along the customer moving path 104. The display screen 113a is directed further to the upstream side than the upstream end 131 of the checkout counter 110. Therefore, the customers 102 lining up in the rear of the customer line 135 can see display information displayed on the display screen 113a of the information display 113. The information display 113 is supported by the pole 130 near the end on the customer side of the bottom surface rather than in substantially the center of the bottom surface (see FIG. 1). The information display 113 is arranged in a position offset further to the store clerk side than the carrying path 136. Therefore, on the top plate 114, a sufficient space for placing the shopping basket 106 is secured from the center to the customer side. The customer 102 can easily move shopping basket 106 forward from the upstream end 131 at the right end of the top plate 114 viewed from the store clerk side and a portion 131a (see FIG. 4) closer to the customer side (arrow A).

The information display 113 can turn around a vertical axis X in a predetermined angle range about a place supported by the pole 130. Therefore, it is possible to turn the information display 113 and direct the display screen 113a thereof further to the upstream side than the upstream end 131 of the checkout counter 110. Even in this case, a portion on the customer side of the information display 113 does not interfere with the space for moving the shopping basket 106 forward secured on the customer side above the top plate 114 of the checkout counter 110.

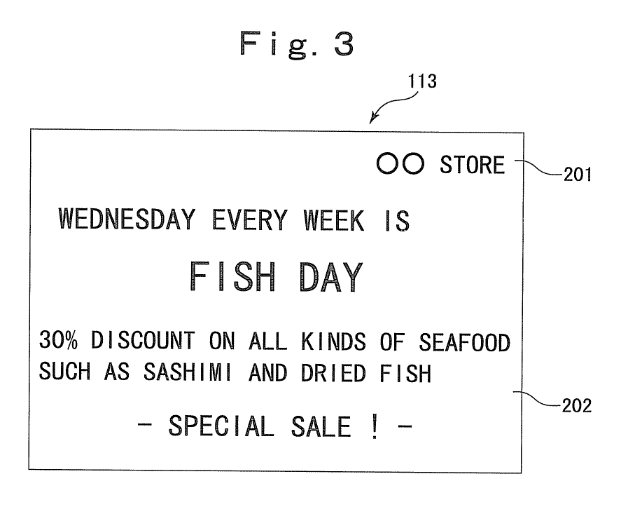

FIG. 2 is a block diagram of an electric configuration of the checkout system 101. First, an electric configuration of the POS terminal 112 is explained. A microcomputer 128 as an information processing unit is stored in the POS terminal 112. The microcomputer 128 includes a CPU 151, a ROM 152, and a RAM 153 and manages the information processing of the entire checkout system 101. The microcomputer 128.is connected to a hard disk 155. Various data files such as a commodity data file F1 and a sales data file F2 are stored in the hard disk 155. Commodity information such as commodity names and commodity unit prices is stored in the commodity data file F1 in association with commodity codes. Sales information is stored in the sales data file F2. Various computer programs including an OS, a driver, and various application programs are also stored in the hard disk 155. Further, a display data file F3 forming display information is also stored in the hard disk 155. The display information is information displayed on the information display 113. The display data file F3 is explained later with reference to FIGS. 3 to 5.

The microcomputer 128 controls to drive a keyboard 125, the settlement work display 126, and a receipt printer 156 as a printing unit. Further, the microcomputer 128 performs data communication with various external apparatuses (the commodity-code input apparatus 111, the information display 113, etc.) via an external apparatus interface 157.

An electric configuration of the commodity-code input apparatus 111 is explained. The commodity-code input apparatus 111 includes a microcomputer 160 that executes information processing. The commodity-code input apparatus 111 includes the code scanner 115, the keyboard 116, the scanning work display 117, the customer display 118, and an external apparatus interface 161. The code scanner 115, the keyboard 116, the scanning work display 117, the customer display 118, and the external apparatus interface 161 are controlled to be driven by the microcomputer 160. The code scanner 115 scans and decodes a commodity code. A commodity code is input from the keyboard 116. The microcomputer 160 outputs to transmit the input commodity code to the POS terminal 112.

The electric configuration of the POS terminal 112 is explained again. The microcomputer 128 executes commodity information storage processing, payment amount calculation processing, storage and saving processing, and receipt issuance processing. The commodity information storage processing is processing for acquiring commodity information corresponding to a commodity code input from the commodity-code input apparatus 111 referring to the commodity data file F1. The payment amount calculation processing is processing for determining, when it is determined that a closing command is input from the keyboard 125, that the input of the commodity code 119 is completed and calculating a payment amount of the customer 102 on the basis of the commodity information. The storage and saving processing is processing for storing and saving sales information in the sales data file F2 when it is determined that a deposit amount and a settlement declaration from the customer 102 are input from the keyboard 125. The sales information is information including the input commodity code 119, the payment amount, and the like. The receipt issuance processing is processing for controlling to drive the receipt printer 156 to print and issue a receipt (not shown) from the receipt sheet discharge port 127.

FIG. 3 is a schematic diagram of an example of display information displayed on the information display 113. Display data is stored in the hard disk 155. The display data is an aggregate of text data, image data, and moving image data. The display data is displayed on the information display 113 and appears as a store name logo 201 and a message 202 (see FIG. 3). In other words, the display data forms display information displayed on the information display 113. The microcomputer 128 executes display processing for combining display data stored in the display data file F3 to form display information (shown in FIG. 3) and causing the information display 113 to display the display information.

Various data forming the display information may be stored in a store controller (not shown). The store controller is set in a backyard of a supermarket and connected to the checkout system 101 via a LAN network (not shown). The store controller delivers the various data forming the display information to the POS terminal 112 periodically or in response to reception of a data transmission request signal transmitted and output from the POS terminal 112. When the delivered various data are received, the microcomputer 128 of the POS terminal 112 combines the received data and displays the data on the information display 113.

The various data forming the display information may be stored in a data delivery server (not shown) on the Internet (not shown) on which the POS terminal 112 performs communication via the LAN network. In this case, like the store controller, the data delivery server delivers the various data forming the display information to the POS terminal 112 periodically or in response to reception of the data transmission request signal transmitted and output from the POS terminal 112.

An example of the display information displayed on the information display 113 is an advertisement shown in FIG. 3 concerning the commodity 105 sold in the supermarket. In the example shown in FIG. 3, the store name logo 201 indicating a store name is displayed on the upper right of the information display 113. The message 202 is displayed over the entire information display 113 together with this store name logo 201. The message 202 indicates promotion content “Wednesday every week is Fish Day 30% discount on all kinds of seafood such as sashimi and dried fish Special Sale!”. The microcomputer 128 included in the POS terminal 112 causes the information display 113 to display the message 202 without associating the message 202 with the commodity information storage processing and the settlement processing.

FIG. 4 is a plan view of a state in which the customers 102 line up to wait for their turns for checkout transactions. In the supermarket, the checkout system 101 is installed. The customers 102 put the commodities 105 planned to be purchased in the shopping baskets 106 and go to the register area. The customer line 135 is formed near the checkout counter 110. The customer line 135 includes a front customer 102a who is performing checkout transactions with the store clerk 103 and waiting customers 102b to 102d l who line up following the front customer 102a to wait for their turns for checkout transactions. The customer line 135 extends in a direction toward the POS terminal 112 along the customer moving path 104. In this case, the customer 102 who goes to the register area lines up at the very end of the customer line 135. In the following explanation, the new customer 102 lining up at the very end of the customer line 135 is referred to as waiting customer 102e who lines up in the customer line 135.

The store clerk 103 is waiting in front of the checkout counter 110. The store clerk 103 positions the shopping basket 106 carried by the customer 102 in the basket placing area 134. Subsequently, the store clerk 103 takes out the commodity 105 planned to be purchased stored in the shopping basket 106. The store clerk 103 inputs the commodity code 119 attached to the commodity 105 to the POS terminal 112 using the code scanner 115. The store clerk 103 may use the keyboard 116 for the input of the commodity code 119. After inputting the commodity codes 119 for all the commodities 105 in the shopping basket 106, the store clerk 103 faces the POS terminal 112. The store clerk 103 performs operation input from the keyboard 125 and performs settlement work based on the input commodity code 119. In the checkout system 101 according to this embodiment, settlement processing performed by the POS terminal 112 (see FIG. 1) and display processing for displaying display information on the information display 113 are executed by the microcomputer 128 included in the POS terminal 112.

The waiting customers 102b to 102e have to line up without leaving the customer line 135 until their turns for performing checkout transactions with the store clerk 103 come. While lining up, the waiting customers 102c to 102e (who stands in the rear of the customer line 135) can see display information displayed on the information display 113 arranged further on the upstream side of the carrying path 136 than the commodity-code input apparatus 111. Therefore, in the checkout system 101 according to this embodiment, the customers 102 waiting for checkout transactions can acquire various kinds of display information displayed on the information display 113 while waiting. Therefore, the stress (dissatisfaction) that the customers 102 feel because they cannot do anything but to line up to wait for checkout transactions is reduced. When the advertisement including the message 202 is displayed on the information display 113 (see FIG. 3), the waiting customers 102c to 102e can learn contents of various advertisements in the supermarket while waiting for their turns for checkout transactions. Even before lining up in the customer line 135, the customers 102 can see the various kinds of display information displayed on the information display 113. As an example, when the information display 113 displays indication (not shown) that the POS terminal 112 is in an unusable state, the customers 102 learn whether the POS terminal 112 associated with the information display 113 is used. As another example, when the information display 113 displays indication (not shown) that a limited-time sale discount is carried out, the customers 102 learn that the limited-time sale discount is performed in the supermarket.

Each of the waiting customers 102b to 102e moves forward on the customer moving path 104 according to a transaction state of checkout transactions that the front customer 102a is performing with the store clerk 103. The waiting customer places the shopping basket 106 on the top plate 114 at the right time when there is an area enough for the waiting customer to place the shopping basket 106 on the top plate 114 of the checkout counter 110. When the waiting customer places the shopping basket 106, the waiting customer lifts the shopping basket 106 up to the portion 131a closer to the customer side at the upstream end 131 of the top plate 114. Subsequently, the waiting customer slides the shopping basket 106 from the portion 131a closer to the customer side to the inner side of the top plate 114. The store clerk 103 grips the shopping basket 106 moved from the upstream end 131 and slides and carries the shopping basket 106 along the carrying path 136 for the commodity 105 formed by the top plate 114. The store clerk 103 positions the shopping basket 106 in the basket placing area 134 on the right of the commodity-code input apparatus 111. As shown in FIGS. 1 and 4, the information display 113 is offset to the store clerk side relative to the carrying path 136 and projects in a direction toward the outer side from the top plate 114. Therefore, further on the customer side than the information display 113 above the checkout counter 110, a basket passing space 137 for sliding the shopping basket 106 is secured. The customers 102 and the store clerk 103 can put the shopping baskets 106 on the top plate 114 from the portion 131a closer to the customer side at the upstream end 131, slide the shopping baskets 106 on the top surface of the top plate 114, and position the shopping baskets 106 in the basket placing area 134 without hitting the shopping baskets 106 against the information display 113.

Obviously, numerous modifications and variations of the present invention are possible in light of the above teachings. It is therefore to be understood that within the scope of the appended claims, the invention may be practiced otherwise than as specifically described herein.

What is claimed is:

1. A checkout system comprising:
a checkout counter that is arranged between a store clerk side and a customer side and specifies a moving path of customers on the customer side;
a commodity-code input unit that is arranged on a top surface of the checkout counter and used for inputting commodity code;
a settling unit that is arranged further on a downstream side than the commodity-code input unit in a flow of commodities in checkout transactions performed by using the commodity-code input unit and performs settlement based on a commodity code input from the commodity-code input unit;
a display unit that is arranged offset to the store clerk side with respect to the checkout counter and has a display screen for displaying information; and
an information processing unit that executes processing for causing the display unit to display display information, wherein
the display screen is directed further to an upstream side of the flow than the commodity-code input unit and further to the upstream side than a position of an upstream end of the checkout counter in the moving path.

2. The system according to claim 1, further comprising a pole that supports the display unit, wherein
the display unit is supported by the pole near a customer side end of a bottom surface thereof and is arranged closer to the store clerk side.
